(19) United States
(12) Patent Application Publication
(10) Pub. No.: US 2026/0056772 A1
(43) Pub. Date: Feb. 26, 2026

(54) DEPLOYING WORKLOADS ON COMPUTING DEVICES FOR MOBILE VEHICLES

(71) Applicant: International Business Machines Corporation, Armonk, NY (US)

(72) Inventors: Akira SAITO, Ichikawa-shi (JP); Hayato UENOHARA, Funabashi-shi (JP); Masakuni OKADA, Abiko-shi (JP); Kiichi FUKUYA, Soka (JP); Mitsuru CHINEN, Yokohama-shi (JP); Sanehiro FURUICHI, Setagaya-ku (JP); Takeshi WATANABE, Kawasaki (JP); Takuya MATSUNAGA, Ichikawa-shi (JP)

(21) Appl. No.: 18/810,500

(22) Filed: Aug. 20, 2024

(51) Int. Cl. G06F 9/48; H04W 4/029

(52) U.S. Cl. CPC G06F 9/4881; G06F 9/485; H04W 4/029

(57) ABSTRACT

A server may determine a start time to start executing workloads associated with services provided by a mobile vehicle. The start time may be determined based on historical data and statistical information regarding an amount of preparation time for the mobile vehicle to prepare to provide the services. The server may determine a duration of service time for executing the workloads. The duration of service time may be determined based on data regarding an amount of preparation time for the mobile vehicle to provide the services. The server may determine, based on the start time and the duration of service time, one or more computing devices that are capable of executing the workloads during the duration of service time. The server may cause the one or more computing devices to start executing the workloads at the start time.

### BACKGROUND

The present invention relates to deploying workloads on computing devices, and for example, relates to deploying workloads on computing devices for services provided by mobile vehicles. A workload may include an amount of time and an amount of computational resources a system or network takes to complete a task or generate a particular output. As an example, the workload may be an application. The workload may be executed on different computing devices.

### SUMMARY

In some implementations, a system comprising: a mobile vehicle to provide services; computing devices to execute workloads associated with the services; and a server to: determine a start time to start executing the workloads, wherein the start time is determined based on data regarding an amount of preparation time for the mobile vehicle to prepare to provide the services in an area; determine a duration of service time for executing the workloads, wherein the duration of service time is determined based on data of a schedule of the mobile vehicle and data regarding forecasted traffic congestion in an area; determine one or more computing devices, of the computing devices, based on the start time and the duration of service time; cause the one or more computing devices to start executing the workloads at the start time; and cause the one or more computing devices to terminate executing the workloads after the duration of service time following the start time.

In some implementations, a computer-implemented method includes determining a start time to start executing workloads associated with services provided by a mobile vehicle in an area, wherein the start time is determined based on historical data and statistical information regarding an amount of preparation time for the mobile vehicle to prepare to provide the services; determining a duration of service time for executing the workloads, wherein the duration of service time is determined based on data of a schedule of the mobile vehicle and data regarding forecasted traffic congestion in the area; determining, based on the start time and the duration of service time, one or more computing devices that are capable of executing the workloads during the duration of service time; and causing the one or more computing devices to start executing the workloads at the start time, wherein the one or more computing devices execute the workloads for the duration of service time following the start time.

In some implementations, a computer program product comprising: one or more computer readable storage media, and program instructions collectively stored on the one or more computer readable storage media, the program instructions comprising: program instructions to determine a start time to start executing the workloads, wherein the start time is determined based on data regarding an amount of preparation time for the mobile vehicle to prepare to provide the services in an area; program instructions to determine a duration of service time for executing the workloads, wherein the duration of service time is determined based on data of a schedule of the mobile vehicle and data regarding forecasted traffic congestion in the are; program instructions to determine one or more computing devices, of the computing devices, based on the start time and the duration of service time; program instructions to cause the one or more computing devices to start executing the workloads at the start time, wherein the one or more computing devices execute the workloads for the duration of service time following the start time

### BRIEF DESCRIPTION OF THE DRAWINGS

FIG. 1 is a diagram of an example system described herein.

FIG. 2A-2I is a diagram of an example implementation of deploying workloads on computing devices for mobile vehicles herein.

FIG. 3 is a diagram of an example computing environment in which systems and/or methods described herein may be implemented.

FIG. 4 is a diagram of example components of one or more devices of FIG. 1.

FIG. 5 is a flowchart of an example process associated with deploying workloads on computing devices for mobile vehicles.

### DETAILED DESCRIPTION

The following detailed description of example implementations refers to the accompanying drawings. The same reference numbers in different drawings may identify the same or similar elements.

Computing devices may execute workloads. The workloads may range in various levels of complexity. Executing the workloads may consume computational resources of the computing devices. In some situations, the computing devices may execute the workloads to assist a mobile vehicle with respect to services provided by the mobile vehicle. By executing the workloads, the computing devices may perform computing tasks. For example, the computing devices may perform computing tasks relating to the services (e.g., perform computing tasks that facilitate the mobile vehicle providing the services).

In some situations, as part of executing the workloads, the computing devices may host web services regarding the services provided by the mobile vehicle. For example, the computing devices may host a website regarding the services provided by the mobile vehicle. For instance, the computing devices may provide, to a user device, information regarding the services.

Additionally, or alternatively, the computing devices may process information received, via the website, from the user device. The computing devices may provide the information, received from the user device, to the mobile vehicle to enable the mobile vehicle to provide the services to a user of the user device.

When a user accesses a website which provides a service, the user needs to know a uniform resource locator (URL) of the website. However, it is difficult to know the URL of the service which a coming mobile vehicle provides, because users often do not know when and which vehicle comes to provide a service beforehand.

Because of the mobile nature of the mobile vehicle, a uniform resource locator (URL) of the website may change as the mobile vehicle moves from one location to another. The change of URL may not be communicated to the user device. Accordingly, as the URL changes, the user device may make repeated unsuccessful attempts to access the URL. Making repeated unsuccessful attempts in this manner consumes computational resources of the user device, consumes network resources of a network associated with the user device.

Additionally, the mobile vehicle may provide the services during limited operating hours. In this regarding, the website may become unavailable outside of the operating hours. The operating hours may not be communicated to the user device. Additionally, the user device may not receive information indicating when the mobile vehicle is operating at a location within a distance threshold of the user device. Accordingly, the user device may make repeated unsuccessful attempts to access the URL outside of the operating hours and/or when the mobile vehicle is not located within the distance threshold of the user device. Making repeated unsuccessful attempts in this manner consumes computational resources of the user device, consumes network resources of a network associated with the user device.

Furthermore, in some situations, the computing devices may continue to host the web services after the mobile vehicle has been relocated. By continuing to host the web services in this manner, the computing devices may consume unnecessary computational resources associated with performing computational tasks for the web services, storage resources associated with storing data for the web service, and/or network resources associated with the web services.

Implementations described herein are directed to addressing the technical problems discussed above regarding the user device, the mobile vehicle, and the computing devices. For example, implementations described herein are directed to a system that detects when a mobile vehicle arrives at a location where the mobile vehicle is to operates that day, determines when the mobile vehicle becomes ready to provide services, and deploys workloads on computing devices associated with the location after the mobile vehicle become ready to provide the services.

The workloads may be deployed to assist with providing and processing information for as web services relating to the services provided by the mobile vehicle. The computing devices may include edge devices (e.g., edge servers) or cloud infrastructures. The computing devices may include edge devices that are closest to the location. Additionally, or alternatively, the computing devices may include additional mobile vehicles. After the workloads have been deployed, the system may cause notifications to be provided to user devices with a distance threshold of the mobile vehicle.

The notifications may include information identifying network locations of the computing devices (e.g., uniform resource identifiers of the computing devices). In some examples, the notifications may be provided via inaudible sound (e.g., a sound at frequency range that is inaudible to human ears). In this regard, the notifications may notify users, of the user devices, that the mobile vehicle has arrived at the location and is ready to provide the services. The notifications may be provided via a notification system of the mobile vehicle (e.g., via a speaker of the mobile vehicle). Additionally, or alternatively, the notifications may be provided via one or more additional mobile vehicles. In this regard, the one or more additional mobile vehicles may provide the notifications to user devices that are located remotely from the mobile vehicle. For example, the one or more additional mobile vehicles may cover additional portion of a geographical area served by the computing devices that are not within reach of the notification system of the mobile vehicle.

Based on the foregoing, implementations described herein are directed to automatically deploying workloads for providing services when the mobile vehicle starts operating and automatically terminating the workloads when the mobile vehicle has moved a different location. By deploying and terminating the workloads as described herein, implementations described herein may preserve the computational resources, the storage resources, and/or the network resources that would have been consumed by allowing to remain deployed on computing devices.

Additionally, implementations described herein are directed to automatically providing, to user devices, notifications identifying network locations of the workloads (e.g., network locations of the computing devices). By automatically providing the notifications as described herein, implementations described herein may preserve the computational resources, the storage resources, and/or the network resources that would have been consumed by the user devices unsuccessfully attempting to access the computing devices for the services provided by the mobile vehicle. Moreover, implementations described herein are directed to determining locations of user devices that may request the services and providing information regarding the locations to the mobile vehicle.

While examples described herein are provided with respect to mobile vehicles, implementations described herein are applicable to stationary vehicles that provide services. In other words, while examples described herein are provided with respect to mobile vehicles that move to different locations to provide services, implementations described herein are applicable to stationary vehicles that provide services at a single location.

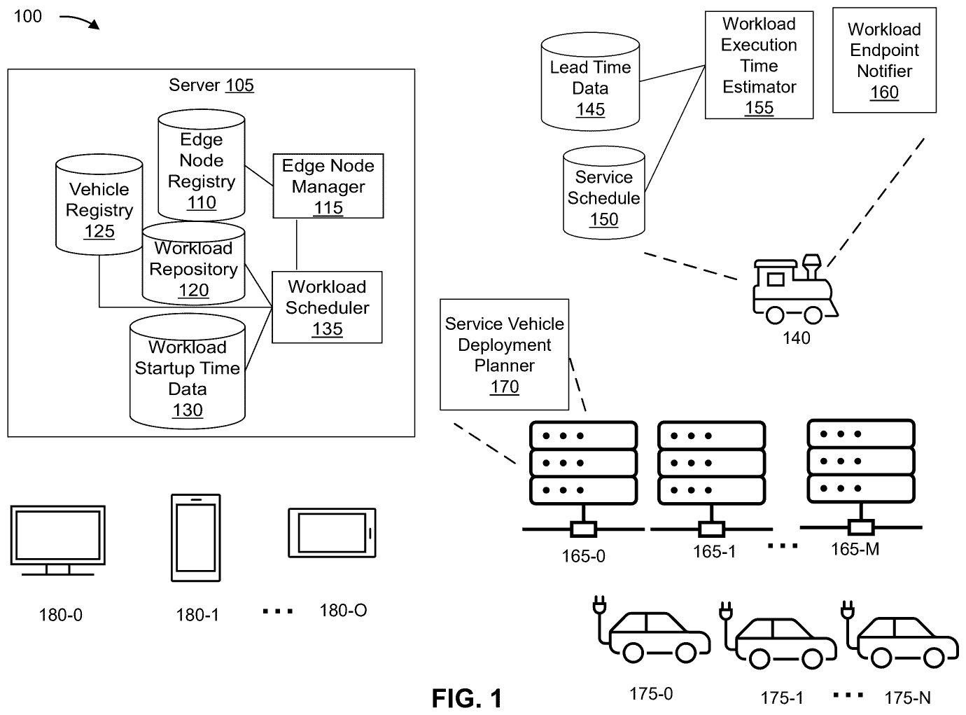

FIG. 1 is a diagram of an example system 100 described herein. As shown in FIG. 1, system 100 may include a server 105, a mobile vehicle 140, a first edge device 165-0, a second edge device 165-1, up to an edge device 165-M (collectively “edge devices 165” and individually “edge device 165”), a first additional mobile vehicle 175-0, a second additional mobile vehicle 175-1, up to an additional mobile vehicle 175-N (collectively “additional mobile vehicles 175” and individually “additional mobile vehicle 175”), a first user device 180-0, a second user device 180-1, up to a user device 180-O (collectively user device 180).

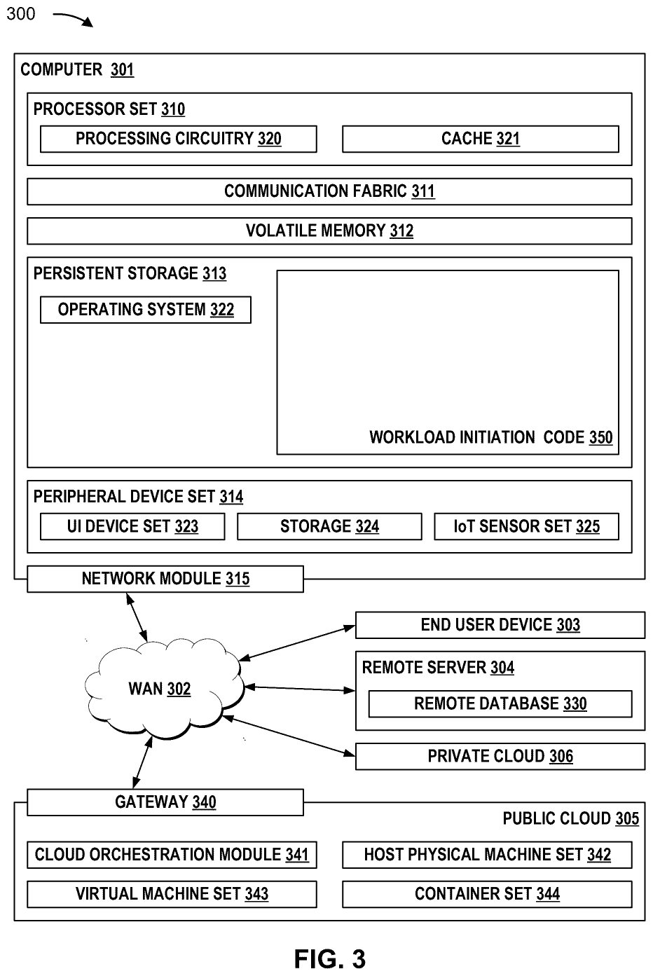

These devices are described in more detail below in connection with FIG. 3. In some examples, mobile vehicle 140 may provide food serving services and a computing device (e.g., an edge device 165 and/or an additional mobile vehicle 175) may execute a workload to provide web services, such as a web site for the food serving service and/or for processing ordering and payment of the food. Additionally, or alternatively, mobile vehicle 140 may provide services relating to an emergent event. In this regard, server 105 may cause one or more computing devices to start executing workloads for services relating to the emergent event. The workloads may be executed to enable mobile vehicle 140 to provide services for the emergent event.

Server 105 includes one or more devices capable of receiving, generating, storing, processing, providing, and/or routing information associated with deploying workloads on computing devices, as described elsewhere herein. Server 105 may include a communication device and/or a computing device. For example, server 105 may include a server, such as an application server, a client server, a web server, a database server, a host server, a proxy server, a virtual server (e.g., executing on computing hardware), or a server in a cloud computing system. In some implementations, server 105 includes computing hardware used in a cloud computing environment As shown in FIG. 1, server 105 may include an edge node registry 110, an edge node manager 115, a workload repository 120, a vehicle registry 125, a workload startup time data 130, and a workload scheduler 135. Edge node registry 110 may include a data store, a database or the like in a data structure, e.g., a table, and/or a linked list or the like, that stores edge device information regarding an edge device, such as an edge device 165. In some examples, edge device information of an edge device 165 may identify a computing capability of the edge device 165, a data storage capability of the edge device 165, a networking capability of the edge device 165, a location of the edge device 165, an availability of the edge device 165 (e.g., dates and times of availability to perform computational tasks), among other examples.

Edge node manager 115 may include one or more devices that identify and select computing devices to execute workloads regarding services provided by mobile vehicle 140. Edge node manager 115 may identify and select the computing devices based on capabilities of the computing devices, availability of the computing devices, and/or costs associated with utilizing the computing devices, among other examples. In some implementations, edge node manager 115 may perform a lookup of edge node registry 110, using information regarding the workloads regarding the services to be provided by mobile vehicle 140, to identify the computing devices.

In some implementations, edge node manager 115 may select one or more additional mobile vehicles 175 as the computing devices. In some examples, edge node manager 115 may select the one or more additional mobile vehicles 175 using vehicular fog computing. In some implementations, edge node manager 115 may perform a lookup of vehicle registry 125, using information regarding the workloads, to identify the one or more additional mobile vehicles 175. Edge node manager 115 may provide information regarding the computing devices to workload scheduler 135.

Workload repository 120 may include a data store, a database or the like in a data structure, e.g., a table, and/or a linked list or the like, that stores workload information regarding workloads. In some implementations, workload repository 120 may store information identifying workloads for different mobile vehicles. For example, workload repository 120 may store one or more first workloads in association with a first mobile vehicle, one or more second workloads in association with a second mobile vehicle, and so on.

The workloads may implement web services, websites, information processing sites, among other examples. In some implementations, the information regarding the workloads may identify computing capabilities to execute the workloads, data storage capabilities to store data to execute the workloads, and/or networking capabilities to execute the workloads.

Vehicle registry 125 may include a data store, a database or the like in a data structure, e.g., a table, and/or a linked list or the like, that stores vehicle information regarding an additional mobile vehicle, such as an additional mobile vehicle 175. In some examples, vehicle information of an additional mobile vehicle 175 may identify a computing capability of the additional mobile vehicle 175, a data storage capability of the additional mobile vehicle 175, a networking capability of the additional mobile vehicle 175, a location of the additional mobile vehicle 175, an availability of the additional mobile vehicle 175 (e.g., dates and times of availability to perform computational tasks), among other examples. In some implementations, vehicle registry 125 may perform as a component of a vehicular fog computing environment.

Workload startup time data 130 may include a data store, a database or the like in a data structure, e.g., a table, and/or a linked list or the like, that stores startup time information regarding start times of different workloads. In some situations, the startup time information may include historical start times of the different workloads. In some examples, the startup time information may be used to estimate a start up time of a workload. In some examples, data of startup time may be used while scheduling each workload on edge server.

Workload scheduler 135 may include one or more devices that identify the workloads regarding the services provided by mobile vehicle 140. In some implementations, workload scheduler 135 may perform a lookup of workload repository 120, using information identifying mobile vehicle 140, to identify the workloads regarding the service provided by mobile vehicle 140. Workload scheduler 135 may deploy the workloads to the computing devices selected to execute the workloads. In some implementations, workload scheduler 135 may identify and select computing devices to execute workloads regarding services provided by mobile vehicle 140. Workload scheduler 135 may identify and select the computing devices based on information regarding a start time and an end time of the workloads (e.g., estimated by mobile vehicle 140).

Mobile vehicle 140 may include an automobile, a truck, a trailer, among other examples. As shown in FIG. 1, mobile vehicle 140 may include lead time data 145, service schedule 150, workload execution time estimator 155, and workload endpoint notifier 160. Lead time data 145 may include a data store, a database or the like in a data structure, e.g., a table, and/or a linked list or the like, that stores information that may be used by workload execution time estimator 155 to determine (e.g., estimate) a start time to start executing the workloads and a duration of service time for executing the workloads. For example, lead time data 145 may store historical data and statistical data regarding the amount of time for mobile vehicle 140 to become ready to provide the services. In some examples, the statistical data may include data regarding an amount required for mobile vehicle 140 to become ready to provide the services. In some instances, the statistical data may include data regarding how much time standard mobile vehicles spend to prepare to provide the services.

Service schedule 150 may include a data store, a database or the like in a data structure, e.g., a table, and/or a linked list or the like, that stores information regarding schedules for mobile vehicle 140. For example, service schedule 150 may store data regarding operating dates and hours of mobile vehicle 140 as well data regarding forecasted traffic congestion in an area (that includes the location of mobile vehicle 140) to predict how long mobile vehicle 140 would operate in the location.

Workload execution time estimator 155 may include one or more devices that determine (e.g., estimate) the start time to start executing the workloads and the duration of service time for executing the workloads. Workload execution time estimator 155 may estimate an appropriate amount of delay to execute the workloads after mobile vehicle 140 arrives at the location, in the event some preparations are to be performed to enable mobile vehicle 140 to provide the services after arrival at the location. For example, workload execution time estimator 155 may use the historical data and/or the statistical data to estimate the time involved for mobile vehicle 140 to complete preparations and become ready to provide the services.

In some implementations, workload execution time estimator 155 may include a location monitor component that determines a location of mobile vehicle 140. As an example, the location monitor component may include a Global Positioning System unit.

In some implementations, workload endpoint notifier 160 may generate notifications that includes information regarding the services provided by mobile vehicle 140 and information regarding the computing devices. For example, workload endpoint notifier 160 may modulate sound (e.g., audible and/or inaudible) to provide the information regarding the services provided by mobile vehicle 140 and information regarding the computing devices (e.g., network locations of the computing devices). The notifications may be provided to an output device of mobile vehicle 140 (e.g., a speaker) and/or to one or more user devices 180.

Edge device 165 may include a device that performs data computation at the end (or “edge”) of a network. Edge device 165 may provide computational resources, storage resources, and/or data storage resources for the workloads. Edge device 165 may include an edge server. As shown in FIG. 1, edge device 165 may include service vehicle deployment planner 170. In some implementations, service vehicle deployment planner 170 may identify one or more additional mobile vehicles 175 and instruct the one or more additional mobile vehicles 175 to provide the services. For example, if mobile vehicle 140 delivers goods, service vehicle deployment planner 170 may identify the one or more additional mobile vehicles 175 and instruct the one or more additional mobile vehicles 175 to deliver the goods. In some implementations, service vehicle deployment planner 170 may provide a request to server 105 to identify the one or more additional mobile vehicles 175 and the request may include information regarding the services provided by mobile vehicle 140. Server 105 may query vehicle registry 125 to identify the one or more additional mobile vehicles 175.

In some examples, service vehicle deployment planner 170 may determining locations of user devices 180 that have requested the services or have expressed an interest in the service and may determine a new location for mobile vehicle 140 that may enable mobile vehicle 140 to have access to user devices 180.

Additional mobile vehicle 175 may include an automobile, a truck, a trailer, among other examples. In some implementations, additional mobile vehicle 175 may include one or more devices to provide notifications generated by mobile vehicle 140. In some implementations, additional mobile vehicle 175 may include one or more devices to provide the services on behalf of mobile vehicle 140. In some implementations, mobile vehicle 175 may include an electronic vehicle, a vehicle using a combustion engine, among other examples.

User device 180 may include one or more devices configured to receive, generate, store, process, and/or provide information associated with accessing services provided by mobile vehicle 140, as explained herein. User device 180 may include a communication device and a computing device. For example, user device 180 may include a wireless communication device, a mobile phone, a user equipment, a laptop computer, a tablet computer, a desktop computer, and/or a similar type of device.

As indicated above, FIG. 1 is provided as an example. Other examples may differ from what is described with regard to FIG. 1. The number and arrangement of devices shown in FIG. 1 are provided as an example. There may be additional devices (e.g., a large number of devices), fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

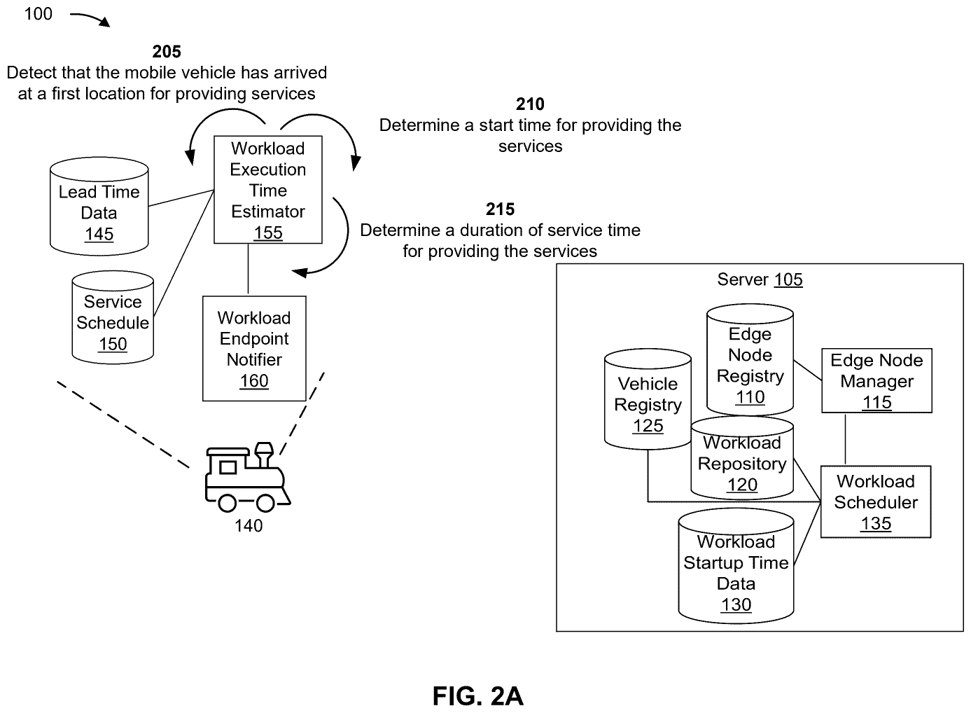

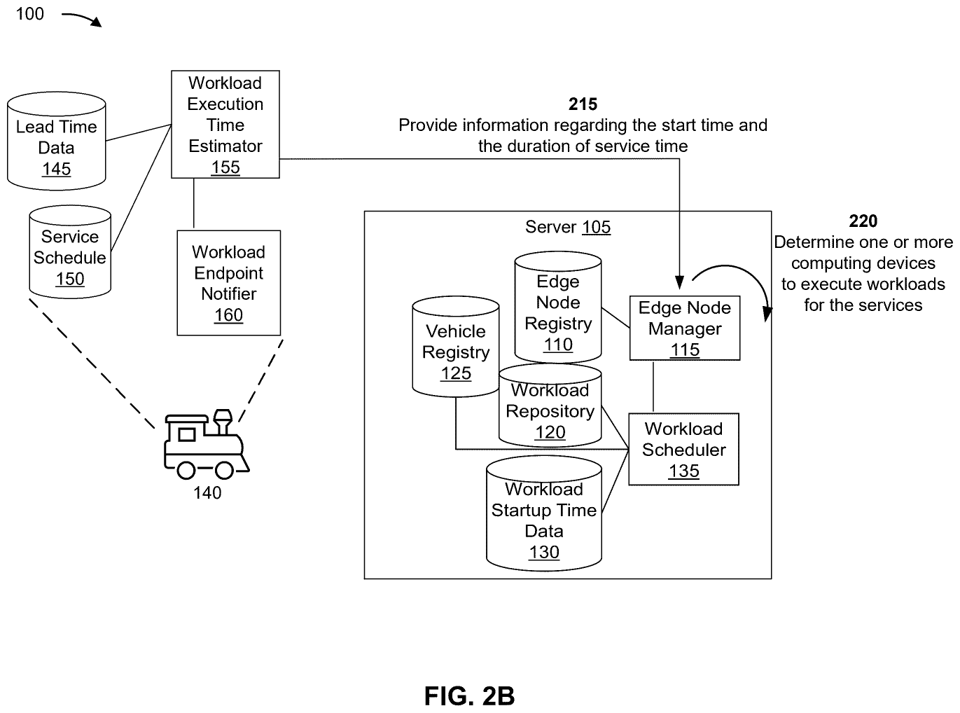

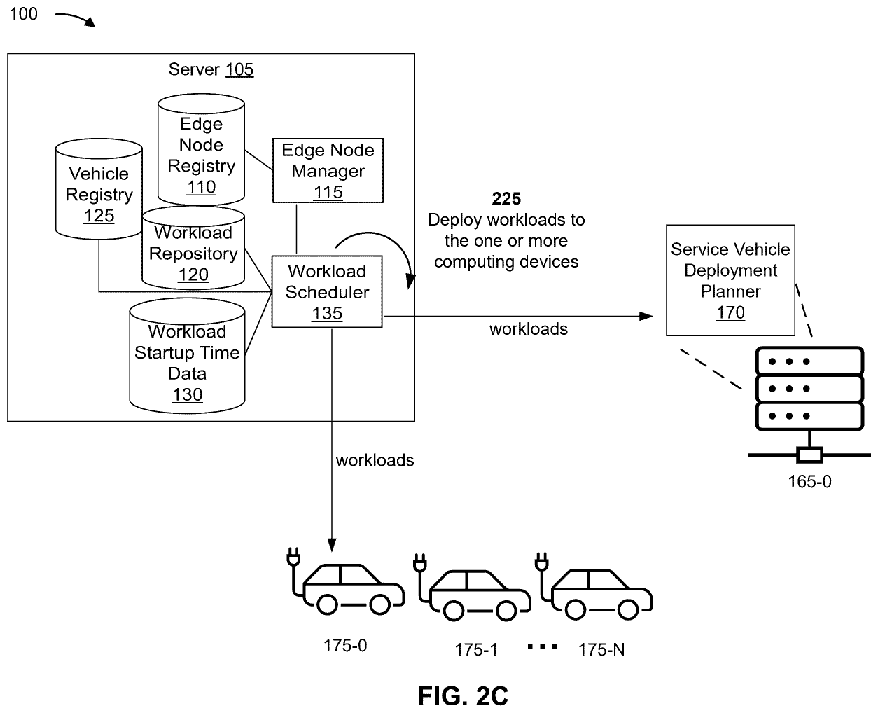

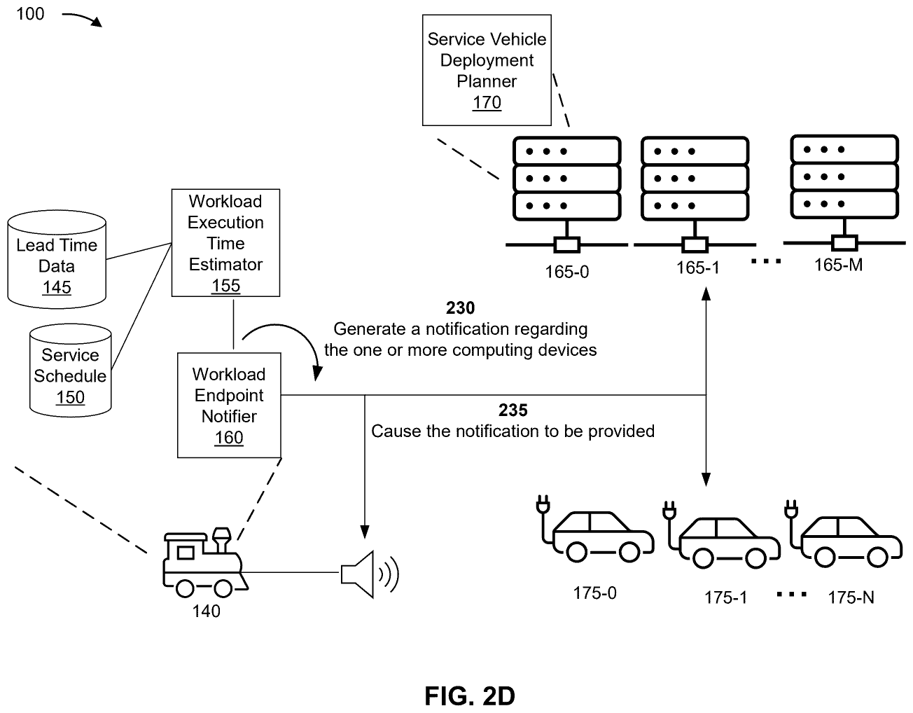

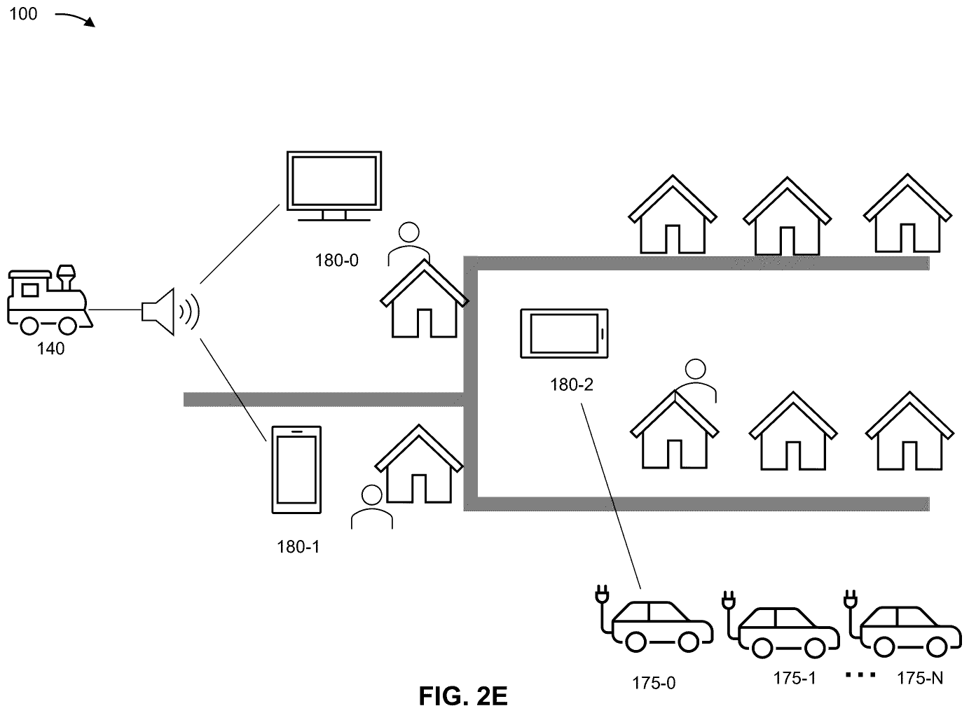

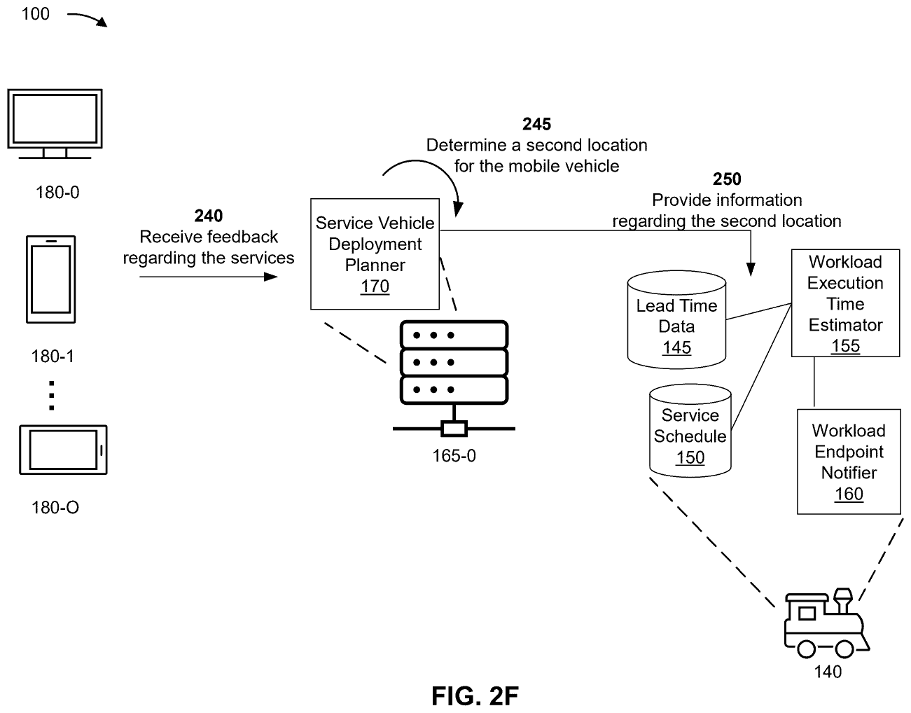

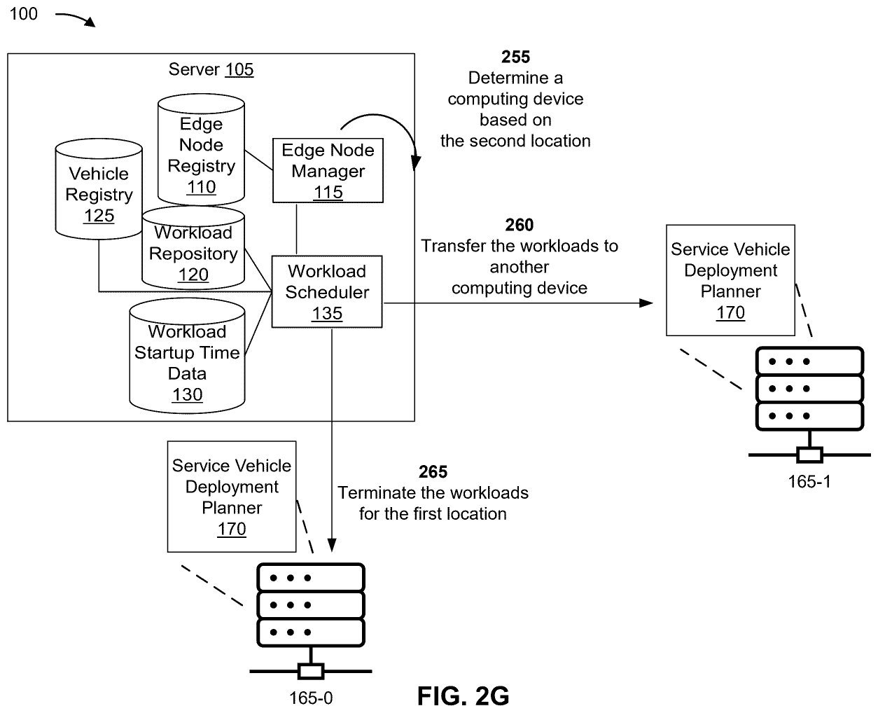

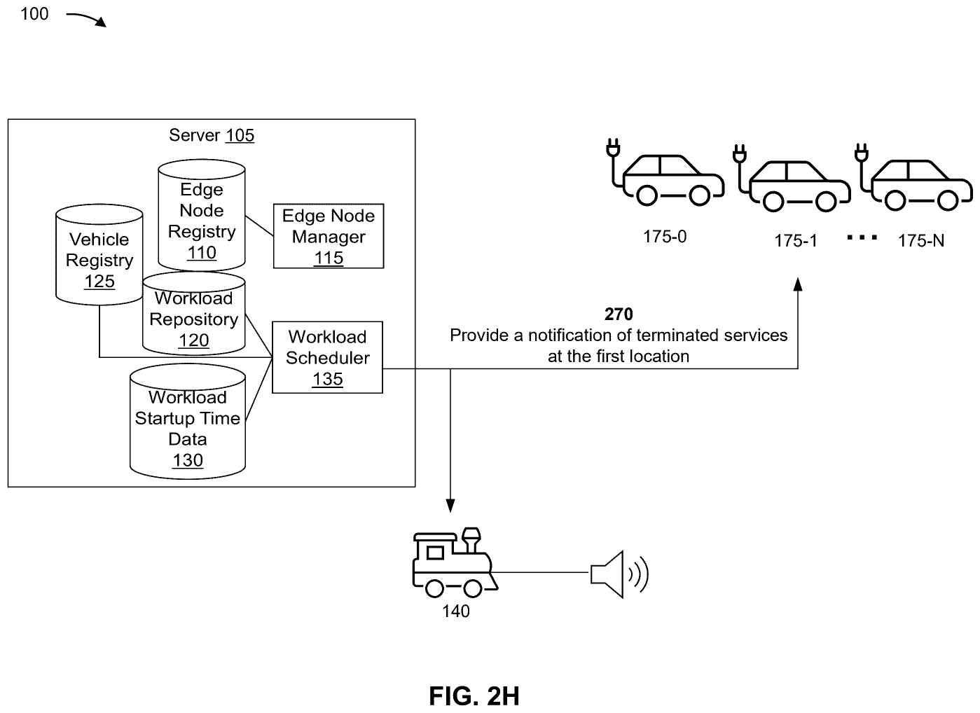

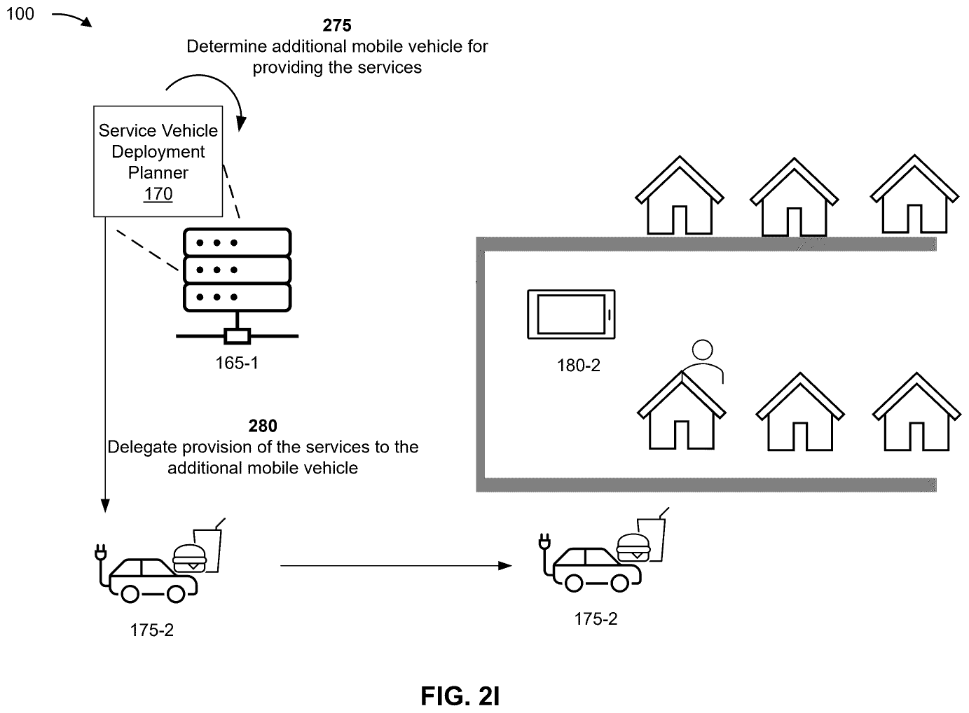

FIGS. 2A-2I are diagrams of an example implementation 200 described herein. As shown in FIGS. 2A-2I, example implementation 200 includes system 100.

As shown in FIG. 2A, and by reference number 205, workload execution time estimator 155 may detect that the mobile vehicle has arrived at a first location for providing services. For example, mobile vehicle 140 may travel to the first location. After detecting that mobile vehicle 140 is stationary for a period of time threshold, workload execution time estimator 155 may detect the first location using the GPS unit and may determine that mobile vehicle 140 has arrived at the first location. Workload execution time estimator 155 may determine mobile vehicle 140 is to provide the services at the first location. In some implementations, workload execution time estimator 155 may use one or more geofencing techniques to detect that mobile vehicle 140 has arrived at the first location. In some implementations, workload execution time estimator 155 may use information regarding an itinerary of mobile vehicle 140 and confirm a stopping point, of the itinerary, to a current location and determine that the current location is the first location.

As shown in FIG. 2A, and by reference number 210, workload execution time estimator 155 may determine a start time for providing the services. For example, after detecting that mobile vehicle 140 has arrived at the first location, Workload execution time estimator 155 may predict a time when the workloads are to be executed. As explained herein, workload execution time estimator 155 may estimate an appropriate amount of delay to execute the workloads after mobile vehicle 140 arrives at the first location, in the event some preparations are to be performed to provide the services after arrival. As explained herein, workload execution time estimator 155 may use the historical data and the statistical data stored in lead time data 145, to determine the start time.

As shown in FIG. 2A, and by reference number 210, workload execution time estimator 155 may determine a duration of service time for providing the services. For example, workload execution time estimator 155 may estimate how long the workloads need to be kept running.

Specifically, workload execution time estimator 155 may use data of the schedule (e.g., operating dates/days and hours) of mobile vehicle 140 and data regarding forecasted traffic congestion of an area (that includes the location) to predict how long mobile vehicle 140 would operate in the location, and then estimates how long the system should keep executing the workloads based on the data.

As shown in FIG. 2B, and by reference number 215, workload execution time estimator 155 may provide information regarding the start time and the duration of service time. For example, after determining the start time and the duration of service time, workload execution time estimator 155 may provide the information regarding the start time and the duration of service time to server 105. For example, workload execution time estimator 155 may provide the information regarding the start time and the duration of service time to edge node manager 115.

As shown in FIG. 2B, and by reference number 220, edge node manager 115 may determine one or more computing devices to execute workloads for the services. For example, after receiving the information regarding the start time and the duration of service time, edge node manager 115 may identify and select one or more computing devices to execute workloads regarding the services provided by mobile vehicle 140. Edge node manager 115 may determine the workloads based on information regarding mobile vehicle 140. In some implementations, edge node manager 115 may perform a lookup of workload repository 220 to identify the workloads associated with mobile vehicle 140. In some implementations, edge node manager 115 may identify and select the one or more computing devices based on capabilities of the computing devices, availability of the computing devices, and/or costs associated with utilizing the computing devices, among other examples.

In some implementations, the computing devices may include one or more edge devices 165. In this regard, edge node manager 115 may perform a lookup of edge node registry 110, using information regarding the workloads for the services to be provided mobile vehicle 140, to identify the one or more edge devices 165. For example, edge node manager 115 may identify devices with computing capabilities, data storage capabilities, and network capabilities to execute the workloads. Additionally, edge node manager 115 may identify devices that are available during the operation hours of mobile vehicle 140.

In some implementations, the computing devices may include one or more additional mobile vehicles 175. In this regard, edge node manager 115 may perform a lookup of vehicle registry 125, using information regarding the workloads for the services to be provided by mobile vehicle 140, to identify the additional mobile vehicles 175. For example, edge node manager 115 may identify additional mobile vehicles 175 with computing capabilities, data storage capabilities, and network capabilities to execute the workloads. In some implementations, vehicle registry 125 may identify equipment included in or support by additional mobile vehicles 175. Additionally, edge node manager 115 may identify devices that are available during the operation hours of mobile vehicle 140.

As shown in FIG. 2C, and by reference number 225, edge node manager 115 may deploy the workloads to the one or more computing devices. For example, after identifying the workloads and selecting the one or more computing devices, edge node manager 115 may provide (to workload scheduler 135) information regarding the workloads and regarding the one or more computing devices. In some implementations, edge node manager 115 may determine the workloads based on information regarding mobile vehicle 140. In some implementations, workload scheduler 135 may perform a lookup of workload repository 120 to identify the workloads associated with mobile vehicle 140.

After determining the workloads, workload scheduler 135 may deploy the workloads to the one or more computing devices. For example, workload scheduler 135 may provide the workloads to the one or more computing devices to cause the one or more computing devices to execute the workloads. In some implementations, when providing the workloads, workload scheduler 135 may provide information regarding the start time and information regarding the duration of the service time to cause the one or more computing devices to execute the workloads at the start time and to continue to execute the workloads during the duration of the service time following the start time.

As shown in FIG. 2D, and by reference number 230, workload endpoint notifier 160 may generate a notification regarding the one or more computing devices. For example, after determining that the start time and the duration of service time, workload endpoint notifier 160 may generate the notification. In some examples, the notification may identify the services provided by mobile vehicle 140. Additionally, the notification may identify a network location of the one or more computing devices. For example, the notification may identify URI and/or URL of the one or more computing devices.

In some implementations, when the workloads become ready, workload scheduler 135 may notify workload endpoint notifier 160. Then, workload endpoint notifier 160 may provide the notification.

In some implementations, workload endpoint notifier 160 may modulate inaudible sound to convey the information regarding mobile vehicle 140 and information regarding the one or more computing devices (e.g., URI and/or URL). In some implementations, workload endpoint notifier 160 may also modulate audible sound to convey the same information.

As show in FIG. 2D, and by reference number 235, workload endpoint notifier 160 may cause the notification to be provided. For example, workload endpoint notifier 160 may cause the notification to be provided user device 180. In some implementations, workload endpoint notifier 160 may provide the notification to one or more additional mobile vehicles 175 and may cause the one or more additional mobile vehicles 175 to provide the notification. User devices 180 may include applications for detecting and processing the modulated audible/inaudible sound.

As shown in FIG. 2E, mobile vehicle 140 (e.g., workload endpoint notifier 160) may provide the notification to user devices 180 within a distance threshold of mobile vehicle 140. As shown in FIG. 2E, an additional mobile vehicle 175 may provide the notification to a user device 180 beyond the threshold distance of mobile vehicle 140. The additional mobile vehicle 175 may use modulated audible/inaudible sound to convey the information (e.g., to convey the notification).

In some implementations, a user device 180 may be configured to receive the notification at a selected time and/or a selected day. In some implementations, the user device 180 may be configured to receive notifications regarding particular types of information (e.g., particular content). In some examples, the particular types of information may be identified by attributes of user device 180. In this regard, server 105 may cause information, associated with the services, to be provided to user device 180. The information may be provided based on one or more attributes of user device 180. Similarly, server 105 may cause different information, associated with the services, to be provided to an additional user device 180. The different information may be provided based on one or more attributes of additional user device 180. In some examples, the attributes of user device 180 may be stored in a memory associated with server 105.

In some implementations, the additional mobile vehicle 175 may be equipped with a speaker device to play audible/inaudible sound. Therefore, workload endpoint notifier 160 may choose vehicles with such speaker device. Workload endpoint notifier 160 may select vehicles using vehicular fog computing environment. For example, workload endpoint notifier 160 may query vehicles with a certain equipment using vehicular fog computing environment.

IN some implementations, workload endpoint notifier 160 may request other vehicles to provide the notification with other methods. For example, workload endpoint notifier 160 may request a vehicle with large external display mounted to display a QR code with the information encoded in the QR code.

In some implementations, edge devices 165 may be installed inside a building (e.g., an office building) to provide the notification with modulated audible/inaudible sound. Workload endpoint notifier 160 may specify a first room that is to receive the notification and a second room that is not to receive the notification. In some implementations, workload endpoint notifier 160 may specify a first target location for sending the notification (by way of an audio format) and specify a second target location for not sending the notification.

In some implementations, workload endpoint notifier 160 may use directional sound for notification to change the endpoint to notify depending on the location of the user. This allows the workload to distinguish between different locations and determine where a user is accessing the endpoint. In some implementations, workload endpoint notifier 160 may change the endpoint to notify depending on the location of the vehicles or Edge devices which do notification on behalf of Workload Endpoint Notifier. This also allows the workload to distinguish between different locations and determine where a customer is accessing the endpoint from.

In some implementations, workload endpoint notifier 160 may utilize multiple frequencies for notifications and change a network location that is announced depending on users. For example, a first user with a first measure of loyalty may receive notifications sent on a first frequency while a second user with a second measure of loyalty may receive notifications sent on a second frequency. In this regard, workload endpoint notifier 160 may provide information regarding special services for loyal user at a selected network location and using a selected range of frequencies.

As show in FIG. 2F, and by reference number 240, an edge device may receive feedback regarding the services. For example, service vehicle deployment planner 170 of edge device 165-0 (that executes the workloads) may receive feedback regarding the services. The feedback may be received from one or more user devices 180. In some examples, the feedback may indicate that users, of the one or more user devices 180, are interested in receiving the services. In some examples, the feedback may identify locations of user devices 180 that have received the services.

As show in FIG. 2F, and by reference number 245, the edge device may determine a second location for mobile vehicle 140 to provide the services. For example, service vehicle deployment planner 170 may determine locations where a number threshold of user devices have accessed the services or have expressed interests in the services. In some implementations, service vehicle deployment planner 170 may select candidate locations where mobile vehicle 140 may park and minimize the sum of distances to user devices.

As show in FIG. 2F, and by reference number 250, the edge device may provide information regarding the second location. For example, mobile vehicle 140 may arrive at the second location. Based on information from the GPS unit, mobile vehicle 140 may detect arrival at the second location. Edge node manager 115 may determine a computing device based on the second location, in a manner similar to the manner described herein.

Mobile vehicle 140 may receive, from edge node manager 115, information about an area that is covered by edge device 165-0 where the workloads are being executed. A location monitor of mobile vehicle 140 may continuously monitors the location of mobile vehicle 140.

As show in FIG. 2G, and by reference number 260, workload scheduler 135 may transfer the workload to another computing device. For example, suppose mobile vehicle 140 moves from Area A to Area B, which is outside of the service area of Edge Server where the workloads are being executed. When location monitor detects that mobile vehicle 140 is moving to Area B, location monitor may request workload scheduler 135 to identify another edge device 165-1 that supports Area B as its service area and move the workloads from edge device 165-0 (servicing Area A) to edge device 165-1 (servicing Area B). Workload scheduler 135 may cause the workload to be transferred. In other words, workload scheduler 135 may cause edge device 165-1 to execute the workloads (instead of edge devices 165-0).

As show in FIG. 2G, and by reference number 265, workload scheduler 135 may cause the workloads to be terminated at the first location. For example, workload scheduler 135 may provide a notification that the workloads has been terminated and workload scheduler 135 may cause edge device 165-0 to terminate executing the workloads.

As show in FIG. 2H, and by reference number 270, workload scheduler 135 may provide a notification of terminated services at the first location. For example, workload scheduler 135 may provide the notification after causing edge device 165-0 to terminate executing the workloads. Workload scheduler 135 may notify users, using an inaudible sound, that mobile vehicle 140 will end the services in Area A. Workload scheduler 135 may notify users using an inaudible sound that mobile vehicle 140 will begin its service in Area B.

As show in FIG. 2I, and by reference number 275, the edge device may determine additional mobile vehicle for providing the services. For example, service vehicle deployment planner 170 may determine additional mobile vehicle 175 for providing the services.

As show in FIG. 2I, and by reference number 275, the edge device may delegate provision of the services to the additional mobile vehicle. For example, service vehicle deployment planner 170 may delegate provision of the services to additional mobile vehicle 175-2. Service vehicle deployment planner 170 may select additional mobile vehicle 175-2 from vehicle registry 125 that can perform a portion of the services. For example, service vehicle deployment planner 170 may identify additional mobile vehicle 175-2 by performing a lookup of vehicle registry 125, and then request additional mobile vehicle 175-2 to perform a portion of the services. For example, if mobile vehicle 140 is a vehicle that provides goods, additional mobile vehicle 175-2 may deliver the goods to locations remote with respect to mobile vehicle 140.

As indicated above, FIGS. 2A-2I are provided as an example. Other examples may differ from what is described regarding FIGS. 2A-2I. The number and arrangement of devices shown in FIG. 1 are provided as an example. A network, formed by the devices shown in FIGS. 2A-2I may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

There may be additional devices (e.g., a large number of devices), fewer devices, different devices, or differently arranged devices than those shown in FIGS. 2A-2H. Furthermore, two or more devices shown in FIGS. 2A-2I may be implemented within a single device, or a single device shown in FIGS. 2A-2I may be implemented as multiple, distributed devices.

Additionally, or alternatively, a set of devices (e.g., one or more devices) shown in FIGS. 2A-2I may perform one or more functions described as being performed by another set of devices shown in FIGS. 2A-2I.

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as read command cancellation code 350. In addition to read command cancellation code 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and read command cancellation code 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in read command cancellation code 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in read command cancellation code 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computational resources of public cloud 305 is performed by the computer hardware and/or software of cloud orchestration module 341. The computational resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computational resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

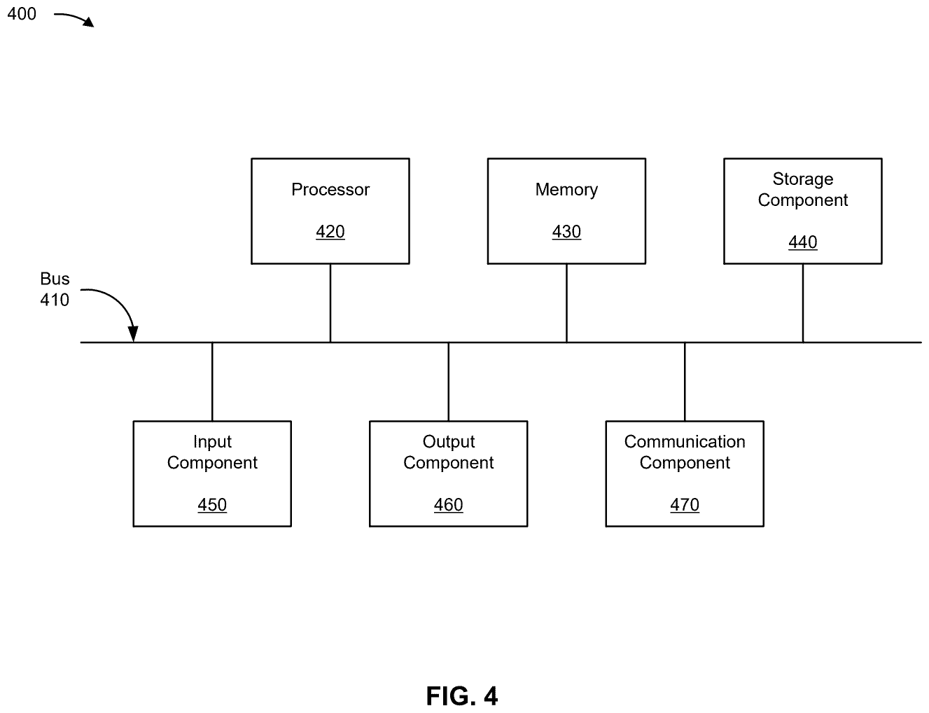

FIG. 4 is a diagram of example components of a device 400, which may correspond to server 105. In some implementations, server 105 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

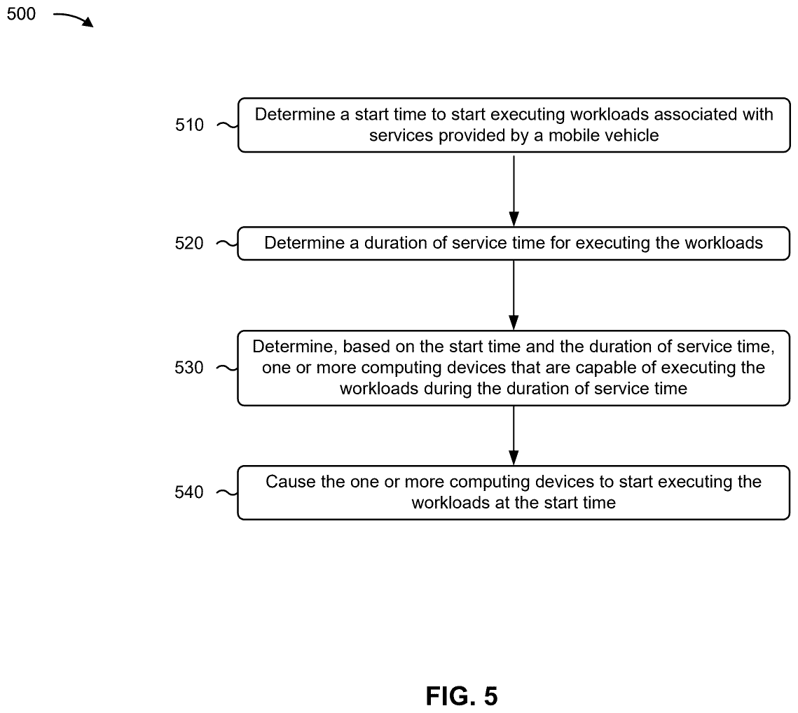

FIG. 5 is a flowchart of an example process 500 associated with cancelling read commands as described herein. In some implementations, one or more process blocks of FIG. 5 may be performed by a server (e.g., server 105). In some implementations, one or more process blocks of FIG. 5 may be performed by another device or a group of devices separate from or including server 105, such as mobile vehicle 140, an edge device 165, and/or an additional mobile vehicle 175. Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include determining a start time to start executing workloads associated with services provided by a mobile vehicle, wherein the start time is determined based on historical data and statistical information regarding an amount of preparation time for the mobile vehicle to prepare to provide the services (block 510). For example, the server may determine a start time to start executing workloads associated with services provided by a mobile vehicle, as described above. In some implementations, the start time is determined based on historical data and statistical information regarding an amount of preparation time for the mobile vehicle to prepare to provide the services.

As further shown in FIG. 5, process 500 may include determining a duration of service time for executing the workloads, wherein the duration of service time is determined based on data regarding an amount of preparation time for the mobile vehicle to provide the services (block 520). For example, the server may determine a duration of service time for executing the workloads, as described above. In some implementations, the duration of service time is determined based on data regarding an amount of preparation time for the mobile vehicle to provide the services.

As further shown in FIG. 5, process 500 may include determining, based on the start time and the duration of service time, one or more computing devices that are capable of executing the workloads during the duration of service time (block 530). For example, the server may determine, based on the start time and the duration of service time, one or more computing devices that are capable of executing the workloads during the duration of service time, as described above.

As further shown in FIG. 5, process 500 may include causing the one or more computing devices to start executing the workloads at the start time, wherein the one or more computing devices execute the workloads for the duration of service time following the start time (block 540). For example, the server may cause the one or more computing devices to start executing the workloads at the start time, as described above. In some implementations, the one or more computing devices execute the workloads for the duration of service time following the start time.

In some implementations, process 500 includes causing an acoustic wave, in an inaudible frequency range, to be provided to the user devices, wherein the sound identifies a uniform resource locator for the one or more computing devices.

In some implementations, process 500 includes causing first information, associated with the services, to be provided to a first user device of the user devices, wherein the first information is provided based on one or more of a first measure of loyalty associated with the first user device, a first type of information requested by the first user device, or a first location of the first user device, and causing second information, associated with the services, to be provided to a second user device of the user devices, wherein the second information is provided based on one or more of a second measure of loyalty associated with the second user device, a second type of information requested by the first user device, or of the first user device.

In some implementations, determining the one or more computing devices that are capable of executing the workloads comprises determining one or more edge servers that are capable of executing the workloads.

In some implementations, determining the one or more computing devices that are capable of executing the workloads comprises determining one or more additional mobile vehicles that are capable of executing the workloads.

In some implementations, process 500 includes causing an additional mobile vehicle to provide a notification, regarding the services, to one or more of the user devices, wherein the notification includes a uniform resource locator for the one or more computing devices, and wherein the one or more of the user devices are located at remote locations with respect to a location of the mobile vehicle.

In some implementations, the one or more computing devices are one or more first computing devices, and wherein the method further comprises determining that the mobile vehicle has moved from a first location to a second location to provide the services, determining, based on the second location, one or more second computing devices, of the computing devices, to execute the workloads associated with the services, causing the one or more second computing devices to execute the workloads based on the mobile vehicle providing the services at the second location.

In some implementations, the one or more computing devices are one or more first computing devices, and wherein the method further comprises causing the one or more first computing devices to terminate executing the workloads based on the mobile vehicle providing the services at the second location, and providing, to the user devices, a notification indicating that the services have been terminated at the first location.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more. ” Further, as used herein, the article “the” is intended to include one or more items referenced in connection with the article “the” and may be used interchangeably with “the one or more. ” Furthermore, as used herein, the term “set” is intended to include one or more items (e.g., related items, unrelated items, or a combination of related and unrelated items), and may be used interchangeably with “one or more. ” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system comprising:
a mobile vehicle to provide services in an area;
computing devices to execute workloads associated with the services; and
a server to:
determine a start time to start executing the workloads,
wherein the start time is determined based on data regarding an amount of preparation time for the mobile vehicle to prepare to provide the services;
determine a duration of service time for executing the workloads,
wherein the duration of service time is determined based on data of a schedule of the mobile vehicle and data regarding forecasted traffic congestion in the area;
determine one or more computing devices, of the computing devices, based on the start time and the duration of service time;
cause the one or more computing devices to start executing the workloads at the start time; and
cause the one or more computing devices to terminate executing the workloads after the duration of service time following the start time.

2. The system of claim 1, wherein the server is to:
cause a notification, regarding the workloads, to be provided to user devices located in an area associated with a location of the mobile vehicle.

3. The system of claim 2, wherein, to cause the notification to be provided, the server is to:
cause a sound, in an inaudible frequency range, to be provided to the user devices,
wherein the sound identifies a uniform resource identifier for the one or more computing devices.

4. The system of claim 2, wherein, to cause the notification to be provided, the server is to:
cause the mobile vehicle and an additional mobile vehicle to provide the notification to the user devices.

5. The system of claim 2, wherein, to cause the notification to be provided, the server is to:
cause first information, associated with the services, to be provided to a first user device of the user devices,
wherein the first information is provided based on one or more first attributes associated with the first user device; and
cause second information, associated with the services, to be provided to a second user device of the user devices,
wherein the second information is provided based on one or more second attributes associated with the second user device.

6. The system of claim 1, wherein, to determine the one or more computing devices, the server is to:
determine the one or more computing devices further based on a location of the mobile vehicle.

7. The system of claim 5, wherein the location is a first location,
wherein the one or more computing devices are one or more first computing devices, and
wherein the server is to:
determine that the mobile vehicle has moved to a second location to provide the services;
determine, based on the second location, one or more second computing devices, of the computing devices, to execute the workloads associated with the services;
cause the one or more second computing devices to execute the workloads based on the mobile vehicle providing the services at the second location; and
cause the one or more first computing devices to terminate executing the workloads based on the mobile vehicle providing the services at the second location.

8. The system of claim 1, wherein the server is to:
determine an additional mobile vehicle of a plurality of additional mobile vehicles that are capable of providing a portion of the services; and
cause the additional mobile vehicle to provide the portion of the services.

9. The system of claim 1, wherein, to cause the one or more computing devices to start executing the workloads, the server is to:
cause the one or more computing devices to start executing the workloads for services relating to an emergent event,
wherein the workloads are executed to enable the mobile vehicle to provide services for the emergent event.

10. A computer-implemented method, comprising:
determining a start time to start executing workloads associated with services provided by a mobile vehicle,
wherein the start time is determined based on historical data and statistical information regarding an amount of preparation time for the mobile vehicle to prepare to provide the services in an area;
determining a duration of service time for executing the workloads,
wherein the duration of service time is determined based on data of a schedule of mobile
vehicle and data regarding forecasted traffic congestion in the area;
determining, based on the start time and the duration of service time, one or more computing devices that are capable of executing the workloads during the duration of service time; and
causing the one or more computing devices to start executing the workloads at the start time,
wherein the one or more computing devices execute the workloads for the duration of service time following the start time.

11. The computer-implemented method of claim 10, further comprising:
cause an acoustic wave, in an inaudible frequency range, to be provided to user devices,
wherein the acoustic wave identifies a uniform resource locator for the one or more computing devices.

12. The computer-implemented method of claim 10, further comprising:
cause first information, associated with the services, to be provided to a first user device of the user devices,
wherein the first information is provided based on one or more of a first measure of loyalty associated with the first user device, a first type of information requested by the first user device, or a first location of the first user device; and
cause second information, associated with the services, to be provided to a second user device of the user devices,
wherein the second information is provided based on one or more of a second measure of loyalty associated with the second user device, a second type of information requested by the first user device, or of the first user device.

13. The computer-implemented method of claim 10, wherein determining the one or more computing devices that are capable of executing the workloads comprises:
determining one or more edge servers that are capable of executing the workloads.

14. The computer-implemented method of claim 10, wherein determining the one or more computing devices that are capable of executing the workloads comprises:
determining one or more additional mobile vehicles that are capable of executing the workloads.

15. The computer-implemented method of claim 10, further comprising:
causing an additional mobile vehicle to provide a notification, regarding the services, to one or more of the user devices,
wherein the notification includes a uniform resource locator for the one or more computing devices, and
wherein the one or more of the user devices are located at remote locations with respect to a location of the mobile vehicle.

16. The computer-implemented method of claim 10, wherein the one or more computing devices are one or more first computing devices, and
wherein the computer-implemented method further comprises:
determining that the mobile vehicle has moved from a first location to a second location to provide the services;
determining, based on the second location, one or more second computing devices, of the computing devices, to execute the workloads associated with the services;
causing the one or more second computing devices to execute the workloads based on the mobile vehicle providing the services at the second location.

17. The computer-implemented method of claim 10, wherein the one or more computing devices are one or more first computing devices, and
wherein the computer-implemented method further comprises:
causing the one or more first computing devices to terminate executing the workloads based on the mobile vehicle providing the services at a second location; and
providing, to the user devices, a notification indicating that the services have been terminated at a first location.

18. A computer program product comprising:
one or more computer readable storage media, and program instructions collectively stored on the one or more computer readable storage media, the program instructions comprising:
program instructions to determine a start time to start executing workloads,
wherein the start time is determined based on data regarding an amount of preparation time for a mobile vehicle to prepare to provide services in an area;
program instructions to determine a duration of service time for executing the workloads,
wherein the duration of service time is determined based on data of a schedule of the mobile vehicle and data regarding forecasted traffic congestion in the area;
program instructions to determine one or more computing devices, of the computing devices, based on the start time and the duration of service time;
program instructions to cause the one or more computing devices to start executing the workloads at the start time,
wherein the one or more computing devices execute the workloads for the duration of service time following the start time.

19. The computer program product of claim 18, wherein the program instructions further comprise:
program instructions to cause a first acoustic wave, in a first frequency range, to be provided to a first user device of the user devices,
wherein the first acoustic wave identifies first information regarding the services; and
program instructions to cause a second acoustic wave, in a second frequency range, to be provided to a second user device of the user devices,
wherein the second acoustic wave identifies second information regarding the services.

20. The computer program product of claim 18, wherein the program instructions further comprise:
program instructions to determine a geographical distribution of user devices;
program instructions to determine a location for the mobile vehicle to provide the services; and
program instructions to provide information identifying the location to the mobile vehicle to cause the mobile vehicle to travel to the location.
